(19) United States
(12) Patent Application Publication
(10) Pub. No.: US 2002/0156673 A1
(43) Pub. Date: Oct. 24, 2002

(54) Automated survey system

(76) Inventor: James Ernest Barker, Perth, WA (US)

Correspondence Address: HILAN CONSULTING PTY LTD, PO BOX 613, HILLARYS W.A., 6025, AU

(21) Appl. No.: 09/843,386

(22) Filed: Apr. 23, 2001

(51) Int. Cl. G06F 17/60

(52) U.S. Cl. 705/10; 705/1

(57) ABSTRACT

An automated survey system is disclosed. This system is an automated voice system 12, a web server 14 and a database means 16. The web server 14 can be accessed by a client 18 or a respondent 22 via a telecommunications network such as the Internet 20. The web server 14 is arranged to allow the client 18 to set up surveys and view survey result data and allow the respondent 22 a method of completing the survey. In order to set up a survey using the automated survey system 10, the client 18 accesses a survey set up page on the web server 14. The survey set up page is designed to allow the client 18 to enter in one or more survey questions in text form and specify a number of pre-defined responses that may be selected in answer to the survey questions. Respondents dialling into the system 24 listen and respond to the Automated Voice System 12 synthesising the text that the Client 18 entered.

The present invention relates to an automated survey system. Many organizations conduct surveys to gather information. This information is used for a range of purposes including market evaluation and customer feedback. Such surveys are commonly conducted by mailing out survey forms or having staff telephone the respondents individually and verbally question them over the telephone. Both of these methods involve the use of significant resources in preparing and distributing or conducting the surveys. The process of compiling the survey results and generating meaningful data is also generally time consuming.

Using the Internet is another method which has been used for conducting surveys. This is generally done by setting up a web page which presents the survey questions to the respondent. The respondent must then enter in the responses to the survey questions via their keyboard and mouse. While this saves time and resources in preparing and conducting the survey, many people find that filling out the survey using this method is too time consuming. Setting up the survey can be a major development exercise on it's own.

The present invention attempts to overcome at least in part some of the aforementioned disadvantages of previous methods for conducting surveys and compiling survey results.

In accordance with one aspect of the present invention there is provided an automated survey system including an automated voice system, a database means and a web server, wherein the automated voice system queries a respondent for responses to one or more survey questions via an audio communication device and the respondent responds by activating an appropriate data input means on the audio communication device, the or each response being stored in the database means, and a data processing means is provided to process the or each response stored in the database means and transmit the results to the web server for graphical display on a web page.

The present invention will now be described, by way of example, with reference to the accompanying drawing, in which:

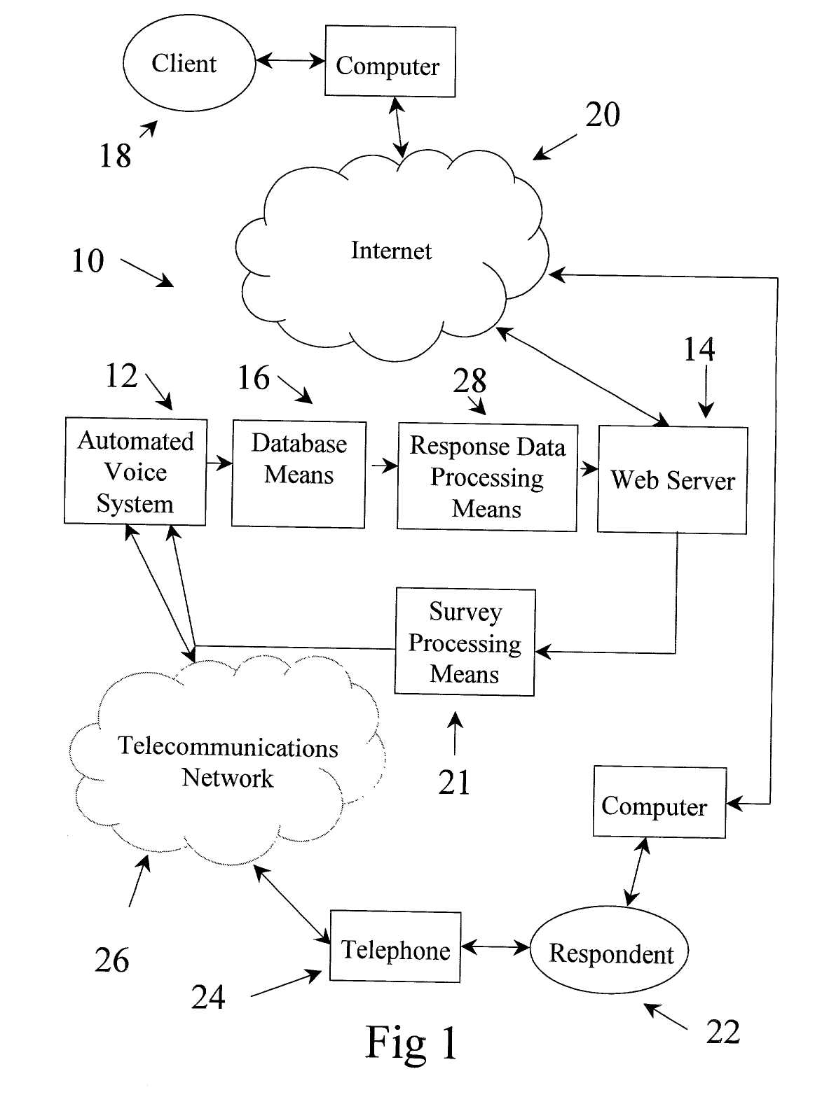

FIG. 1 is a block diagram of the functional elements of an automated survey system in accordance with the present invention.

Referring to FIG. 1, there is shown an automated survey system 10 including an automated voice system 12, a web server 14 and a database means 16.

The web server 14 can be accessed by a client 18 or a respondent 22 via a telecommunications network such as the Internet 20. The web server 14 is arranged to allow the client 18 to set up surveys and view survey result data and allow the respondent 22 a method of completing the survey.

In order to set up a survey using the automated survey system 10, the client 18 accesses a survey set up page on the web server 14. The survey set up page is designed to allow the client 18 to enter in one or more survey questions in text form and specify a number of pre-defined responses that may be selected in answer to the survey questions.

The client can further specify other survey data such as the maximum number of respondents, whether the survey can be completed by a respondent 22 using the Internet 20 or by telephone 24 using the telecommunications network, the time period for which the survey is valid or the type of voice used by the automated voice system 12.

Once the client 18 completes the survey set up page, the information is processed by a survey processing means 21 and transmitted to the automated voice system 12. The survey processing means 21 also returns final survey details to the client 18 by displaying the details on a webpage. The final survey details may include things such as a survey ID number and a telephone number or web page which must be called to participate in the survey. The client 18 then distributes the appropriate survey details to possible respondents by suitable means, such as a display on a web page or by mail.

The automated voice system 12 is arranged to receive calls from respondents 22 using telephones 24 over an existing telecommunications network 26. The automated voice system 12 converts the survey questions entered by the client 18 from text to synthesised voice. When a respondent 22 calls, the automated voice system 12 answers the call and prompts the respondent 22 to enter the appropriate survey details such as survey ID number and password if required. The automated voice system 12 then prompts the respondent to answer the survey questions. The respondent 22 selects one of the pre-defined responses using the keypad of the respondent's telephone 24. Alternatively, the respondent can answer the questions using voice recognition 12. The survey responses are then stored in the database means 16.

Alternatively, the automated voice system 12 may be set up to initiate the call to the respondent 22. The automated voice system 12 would include in this case an electronic telephone directory database and would select numbers from this directory at random or by a pre-defined strategy. For example, the numbers may be selected from one or more geographical areas.

The automated survey system 10 also includes a response data processing means 28. The response data processing means 28 extracts response data from the database means 16 and converts it to a form suitable for graphical display and transmits the formatted data to the web server 14. The response data may be converted, for example, into table or chart format. The formatted data is displayed by the web server 14 on a survey results web page. The client 18 then accesses the survey data page on the web server 16 via the Internet 20 where the client 18 can view an up to date representation of the survey response data.

In an alternate embodiment, the respondent 22 responds to the survey questions using a computer, via the internet. The respondent's computer may have audio capability so that the automated voice system 12 could query the respondent 22. The respondent 22 would then provide responses to the survey questions by pressing an appropriate key on the respondent's computer.

In another form of the invention the text entered by the Client 18 can be read and stored in an audio format of a human voice and played back to the respondent 22 instead of the synthesised speech.

It will be appreciated that the response data processing means 28, database means 16, survey processing means 21 and automated voice system 12 may be implemented in one or more pieces of software on one or more computers. For example the database means 16, the response data processing means 28 and the survey processing means 21 may all be implemented in a software program on a single computer, which also houses the web server 14. The automated voice system 32 may be on a separate telephony computer.

Modifications and variations as would be apparent to a skilled addressee are deemed to be within the scope of the present invention.

The claims defining the invention are as follows:

1. An automated survey system that allows a client to enter questions and responses through the internet in a text format and have the computer system convert the text to speech synthesis for the respondents to listen and reply to using their telephone to connect to the system.

2. The automated survey system of claim 1 wherein the system prints out the survey questions and answers for the client.

3. The automated survey system of claim 1 wherein the client enables the survey immediately by paying utilising a credit card payment gateway.

4. The automated survey system of claim 1 wherein the results obtained from the respondents is collected directly into a database.

5. The automated survey system of claim 1 wherein the results can be displayed to the client immediately on the internet.

6. The automated survey system of claim 1 wherein the computer system uses voice recognition capabilities to collect the respondents answers.

7. The automated survey system of claim 1 wherein the text to speech synthesis is replaced with a human voice reading the text.

8. The automated survey system of claim 1 wherein the respondent can respond to the survey on the internet.
